(19) United States
(12) Patent Application Publication
(10) Pub. No.: US 2020/0377644 A1
(43) Pub. Date: Dec. 3, 2020

(54) FLAME RETARDANT POLYISOCYANURATE FOAM

(71) Applicant: Covestro Deutschland AG, Leverkusen (DE)

(72) Inventors: Yuudai Kashiwamoto, Higashiosaka-city, Osaka (JP); Shigeo Yamamoto, Itami-city, Hyogo (JP)

(21) Appl. No.: 16/770,211

(22) PCT Filed: Dec. 14, 2018
(86) PCT No.: PCT/EP2018/084871

§ 371 Date: Jun. 5, 2020

(30) Foreign Application Priority Data
Dec. 20, 2017 (JP) 2017-244076

(51) Int. Cl. C08G 18/79; C08G 18/18; C08G 18/16; C08G 18/20; C08G 18/42; C08G 18/76; C08K 3/22; C08K 3/02; C08K 5/02; C08G 18/08; E04B 1/94; E04B 1/74

(52) U.S. Cl. CPC C08G 18/794; C08G 2101/0058; C08G 18/1875; C08G 18/161; C08G 18/2018; C08G 18/4202; C08G 18/4211; C08G 18/7671; C08K 3/22; C08K 3/02; C08K 5/02; C08G 18/14; E04B 1/94; E04B 1/74; C08K 2003/2227; C08K 2003/026; C08G 18/1833

(57) ABSTRACT

An object of the present invention is to provide a polyisocyanurate foam having excellent flame retardancy and a heat insulator and building material comprising the same. A flame retardant polyisocyanurate foam produced by curing a mixture comprising a polyol (A), a surfactant (B), a catalyst (C), a blowing agent (D), a polyisocyanate (E) and a flame retardant (F), wherein the catalyst (C) comprises a trimerization catalyst; the water content in the blowing agent (D) is less than 0.2 parts by mass based on 100 parts by mass of the total of the polyol (A) and the polyisocyanate (E); the flame retardant (F) comprises a red phosphorus-based flame retardant and aluminum hydroxide, and the volume average diameter of the aluminum hydroxide is not less than 40 μm when measured by laser diffractometry; the total content of the red phosporus-based flame retardant and the aluminum hydroxide is 6 to 36 parts by mass based on 100 parts by mass of the total of the polyol (A) and the polyisocyanate (E); and the equivalent ratio of an isocyanate group in the polyisocyanate (E) to the total active hydrogen groups contained in the polyol (A), the surfactant (B), the catalyst (C) and the blowing agent (D) (NCO/OH ratio) is more than 2.0.

The present invention relates to a polyisocyanurate foam having excellent flame retardancy and a heat insulator and building material comprising the same.

Heat insulators and building materials including a rigid polyurethane foam are used for energy saving measures in communal buildings such as condominiums, houses, and various facilities such as schools and commercial buildings. This rigid polyurethane foam has small cells (spaces) internally and gas having low thermal conductivity is trapped therein, so that the foam has the effect to suppress heat conduction. In addition, a rigid polyurethane foam is needed to be flame retardant because it is used as a heat insulator for buildings and a building material, and a technique to make a rigid polyurethane foam flame retardant has been recently developed. As such techniques, for example, a process in which a polyisocyanurate is formed by a trimerization reaction and a process in which a flame retardant is added are known. It is known that, in the process in which a polyisocyanurate is formed, an isocyanurate ring is formed by a trimerization reaction of an isocyanate group, so that excellent flame retardancy is exhibited compared to a rigid polyurethane foam (e.g., JP-2009-215511-A). It is known that, in the process in which a flame retardant is added, halogen-based, phosphorus-based, inorganic, nitrogen-based and silicone-based flame retardants are used (e.g., JP-2005-307144-A, JP-H06-279563-A). In addition, it is known that these flame retardants, even alone, exhibit flame retardant effect and that the synergistic effect of the combination of a red phosphorus-based flame retardant and aluminum hydroxide or the combination of a red phosphorus-based flame retardant and inorganic filler on flame retardancy is exhibited (e.g., JP-6200435-B2 and JP-6134421-B2; Report of National Research Institute of Fire and Disaster, No. 81 (March 1996), pp. 7-20: “Evaluation of Combustion Characteristics of Red Phosphorus-containing Fire-Retardant Materials by means of Cone Calorimetry”).

Meanwhile, aluminum hydroxide undergoes dehydration reaction endothermically when it exceeds a certain temperature, so that combustion heat can be suppressed by this endothermic effect and further endothermic effect by heat of vaporization of water from dehydration reaction. In addition, it is known that, as the particle diameter of aluminum hydroxide is smaller (the specific surface area is larger), the decomposition reaction of the aluminum hydroxide is accelerated more, so that higher flame retardant effect is exhibited (Journal of the Society of Rubber Science and Technology, Japan, Vol. 75, No. 8 (2002), pp. 36-38: “Technical Trend of Aluminum hydroxide”).

An object of the present invention is to provide a polyisocyanurate foam having excellent flame retardancy and a heat insulator and building material comprising the same.

According to the present invention, the following invention is provided.

(1) A flame retardant polyisocyanurate foam, produced by curing a raw material mixture comprising a polyol (A), a surfactant (B), a catalyst comprising a trimerization catalyst (C), a blowing agent (D), a polyisocyanate (E) and a flame retardant (F), wherein

the catalyst (C) comprises a trimerization catalyst;

the water content in the blowing agent (D) is less than 0.2 parts by mass based on 100 parts by mass of the total of the polyol (A) and the polyisocyanate (E);

the flame retardant (F) comprises a red phosphorus-based flame retardant and aluminum hydroxide, and the volume average diameter of the aluminum hydroxide is not less than 40 μm when measured by laser diffractometry;

the total content of the red phosphorus-based flame retardant and the aluminum hydroxide is 6 to 36 parts by mass based on 100 parts by mass of the total of the polyol (A) and the polyisocyanate (E); and

the equivalent ratio of an isocyanate group in the polyisocyanate (E) to the total active hydrogen groups contained in the polyol (A), the surfactant (B), the catalyst (C) and the blowing agent (D) (NCO/OH ratio) is more than 2.0.

(2) The flame retardant polyisocyanurate foam according to (1), wherein the mass ratio of the red phosphorus-based flame retardant to the aluminum hydroxide is 1:1 to 1:4.

(3) The flame retardant polyisocyanurate foam according to (1) or (2), wherein the polyol (A) comprises a polyester polyol having the number of the functions of 2 to 3 and the Hydroxyl Number of 100 to 400 mgKOH/g.

(4) The flame retardant polyisocyanurate foam according to any of (1) to (3), wherein the polyol (A) comprises a polyester polyol having the aromatic ring content of 8 to 30% by mass.

(5) The flame retardant polyisocyanurate foam according to any of (1) to (4), wherein the polyisocyanate (E) comprises at least one of an aromatic polyisocyanate and a modified aromatic polyisocyanate.

(6) The flame retardant polyisocyanurate foam according to any of (1) to (5), wherein the blowing agent (D) is at least one selected from the group consisting of a hydrofluoroolefin, hydrochlorofluoroolefin, water and hydrocarbon.

(7) The flame retardant polyisocyanurate foam according to any of (1) to (6), wherein the blowing agent (D) is trans-1-chloro-3,3,3-trifluoropropene.

(8) The flame retardant polyisocyanurate foam according to any of (1) to (7), wherein the core density is 30 to 80 kg/m³.

(9) The flame retardant polyisocyanurate foam according to any of (1) to (8), wherein the Total heat released is not more than 8 MJ/m² when measured by the non-combustibility test based on ISO5660.

(10) A heat insulator, comprising the flame retardant polyisocyanurate foam according to any of (1) to (9).

(11) A building material, comprising the flame retardant polyisocyanurate foam according to any of (1) to (9).

### Effects of the Invention

According the present invention, a flame retardant polyisocyanurate foam having excellent flame retardancy can be provided by using as a flame retardant a red phosphorus-based flame retardant in combination with aluminum hydroxide having a specific volume average diameter. In addition, a flame retardant polyisocyanurate foam obtained by the present invention can be light in weight and may have a high flame retardancy, so that it may be advantageously used in applications of a heat insulator for buildings and a building material.

The present invention will be specifically described in the followings.

### <Flame Retardant Polyisocyanurate Foam>

The flame retardant polyisocyanurate foam according to the present invention is characterized in that it is produced by curing a raw material mixture comprising a polyol (A), a surfactant (B), a catalyst (C), a blowing agent (D), a polyisocyanate (E) and a flame retardant (F), wherein the catalyst (C) comprises a trimerization catalyst; the water content in the blowing agent (D) is less than 0.2 parts by mass based on 100 parts by mass of the total of the polyol (A) and the polyisocyanate (E); the flame retardant (F) comprises a red phosphorus-based flame retardant and aluminum hydroxide, and the volume average diameter of the aluminum hydroxide is not less than 40 μm when measured by laser diffractometry; and the total content of the red phosphorus-based flame retardant and the aluminum hydroxide is 6 to 36 parts by mass based on 100 parts by mass of the total of the polyol (A) and the polyisocyanate (E). It is conventionally known that, when aluminum hydroxide is used as a flame retardant, as the particle diameter of the aluminum hydroxide is smaller, the decomposition reaction of the aluminum hydroxide is accelerated more, so that higher flame retardancy is exhibited, and it is hence a surprising fact that high flame retardancy is exhibited when aluminum hydroxide having a relatively large particle diameter of not less than 40 μm like the present invention.

In the flame retardant polyisocyanurate foam according to the present invention, from the viewpoint of weight saving, an amount of the raw material component can be increased or decreased to appropriately adjust a density and a core density. The density of the flame retardant polyisocyanurate foam according to the present invention is preferably 30 to 80 kg/m³, more preferably 35 to 75 kg/m³.

In addition, the flame retardant polyisocyanurate foam according to the present invention can exhibit excellent flame retardancy. In the present invention, “excellent flame retardancy” means that the Total heat released which is measured by Heat release rate test (cone calorimeter method) of ISO5660 is not more than 8 MJ/m².

It is noted that a measurement method of each characteristics of the density, core density, Total heat released, and the like of the flame retardant polyisocyanurate foam according to the present invention is based on the methods described in examples below.

Hereinafter, each raw material component of the flame retardant polyisocyanurate foam according to the present invention will be further specifically described.

### <Polyol (A)>

As the polyol (A) according to the present invention, a known polyether polyol, polyester polyol, polymer polyol, polyol containing a halogen and/or phosphorus, phenol-based polyol, ethylene glycol, glycerin, amine crosslinker and the like, which have an active hydrogen to react with the polyisocyanate (E) can be used.

Examples of the polyether polyols include polyhydric alcohols such as a glycol, glycerin, trimethylol propane, pentaerythritol, sorbitol and sucrose; aliphatic amine compounds such as ethylamine, triethanolamine, ethylenediamine and diethylenetriamine; and polyether polyols obtained by addition of an alkylene oxide to either single or a mixture of toluenediamine (TDA) and diphenylmethanediamine (MDA).

Examples of the polyester polyols include polyester polyols obtained by ring opening polymerization of a dicarboxylic acid or carboxylic anhydride and a polyhydric alcohol or ε-caprolactone. An aromatic ring content of the polyester polyol is preferably 8 to 30% by mass. When the aromatic ring content of the polyester polyol is in the above range, it is possible that both flame retardancy and moldability of the flame retardant polyisocyanurate foam are obtained at high level. In the present invention, the aromatic ring content means a percentage (%) by mass of a benzene ring contained in each raw material based on the total mass of raw materials used for synthesizing a polyester polyol.

Examples of the polymer polyols include polymer polyols obtained by reacting, using a radical polymerization catalyst, the above-mentioned polyether polyol with an ethylenic unsaturated monomer such as acrylonitrile and styrene.

Examples of the halogen-containing polyols include those obtained by ring opening polymerization of epichlorohydrin and trichlorobutylene oxide, and those obtained by addition of an alkylene oxide to a halogenated polyhydric alcohol.

Examples of the phosphorus-containing polyols include those obtained by addition of an alkylene oxide to phosphoric acid, phosphorous acid or an organic phosphoric acid, and those obtained by addition of an alkylene oxide to a polyhydroxypropylphosphine oxide.

Examples of the phenol-based polyols include those obtained by reacting a novolac or resole resin produced from phenol and formalin with an alkylene oxide, and Mannich base polyols obtained by reacting a phenol with an alkanolamine and formalin alkylene oxide.

In the present invention, one kind of polyol (A) may be used alone or two kinds or more of polyol (A) may be used in combination. The one or more polyol (A) has preferably an average hydroxyl value of 100 to 900 mg KOH/g, more preferably 150 to 800 mg KOH/g, and an average functionality of 2 to 8, more preferably 2 to 6.

In the present invention, the content of the polyol (A) in the raw material mixture of the flame retardant polyisocyanurate foam is not especially limited unless the effect of the present invention is impaired, and can be appropriately selected and, for example, is 10 to 50 parts by mass, preferably 15 to 50 parts by mass, more preferably 20 to 50 parts by mass based on 100 parts by mass of the total of the polyol (A) and the polyisocyanate (E).

### <Surfactant (B)>

As the surfactant (B) according to the present invention, a silicone-based surfactant and fluorine-containing compound-based surfactant can be used. In the present invention, one kind of surfactant (B) may be used alone or two kinds or more of surfactant (B) may be used in combination. The content of the surfactant (B) in the raw material mixture of the flame retardant polyisocyanurate is not especially limited unless the effect of the present invention is impaired, and can be appropriately selected and, for example, is 0.1 to 5 parts by mass, preferably 0.5 to 4.5 parts by mass, more preferably 1.0 to 4.0 parts by mass based on 100 parts by mass of the total of the polyol (A) and the polyisocyanate (E).

### <Catalyst (C)>

As the catalyst (C) according to the present invention, a catalyst comprising a trimerization catalyst is used in order to accelerate the formation of isocyanurate rings which have thermal resistance.

Examples of the trimerization catalysts include aromatic compounds such as tris(dimethylaminomethyl)phenol, 2,4-bis(dimethylaminomethyl)phenol and 2,4,6-tris(dialkylaminoalkyl)hexahydro-S-triazine; carboxylic acid alkaline metal salts such as potassium acetate, potassium 2-ethylhexanoate, potassium octanoate and potassium octoate; and quaternary ammonium salts of carboxylic acids such as triethylmethylammonium 2-ethylhexanoate. In the present invention, one kind of trimerization catalyst may be used alone or two kinds or more of trimerization catalyst may be used in combination.

The catalyst (C) according to the present invention may contain one kind or two or more kinds of urethanization catalysts in addition to a trimerization catalyst. Examples of the urethanization catalysts include tertiary amines such as triethylamine, N,N-dimethylcyclohexylamine, N,N,N′,N′-tetramethyl-1,3-propanediamine, N,N,N′,N″,N″-pentamethyldiethylenetriamine, N,N,N′,N″,N″′,N″′-Hexamethyltriethylenetetramine, bis(2-dimethylaminoethyl) ether, N,N,N′-trimethylaminoethylethanolamine, N,N,N′,N′-tetramethylhexanediamine, triethylenediamine and 1-isobutyl-2-methylimidazole; organic acid salts of tertiary amines; and metal-based catalysts such as dibutyltin dilaurate and stannous octanoate of tertiary amines.

The above-mentioned trimerization catalyst and urethanization catalyst may be used as a mixture with a solvent, respectively. The solvent is not especially limited unless the effect of the present invention is impaired, and can be appropriately selected. Examples of the solvents include glycols such as dipropylene glycol and diethylene glycol.

In the present invention, the content of the trimerization catalyst in the catalyst (C) is not especially limited unless the effect of the present invention is impaired, and can be appropriately selected and, for example, is 0.1 to 5 parts by mass, preferably 0.5 to 2.0 parts by mass, more preferably 1.0 to 1.5 parts by mass based on 100 parts by mass of the total of the polyol (A) and the polyisocyanate (E).

The content of the catalyst (C) in the above mixture of the flame retardant polyisocyanurate is not especially limited unless the effect of the present invention is impaired, and can be appropriately selected and, for example, is 0.1 to 5 parts by mass, preferably 0.5 to 4.5 parts by mass, more preferably 1.0 to 4.0 parts by mass based on 100 parts by mass of the total of the polyol (A) and the polyisocyanate (E).

### <Blowing Agent (D)>

As the blowing agent (D) according to the present invention, water and various known blowing agents can be used.

As a blowing agent other than water, a known blowing agent can be used, and such a blowing agent that does not consume a polyisocyanate nor generate reaction heat is preferably used. Examples of such blowing agent s include chlorofluorocarbon (CFC), hydrochlorofluorocarbon (HCFC), hydrofluorocarbon (HFC), hydrofluoroolefin (HFO), normal pentane, isopentane, cyclopentane, hexane, amine carbonate, formic acid and liquid carbon dioxide. From the viewpoint of global environmental effects, among the above blowing agents other than water, hydrofluoroolefin (HFO), and hydrocarbon compounds such as normal pentane, isopentane, cyclopentane, and hexane is preferably used. Especially preferable examples of hydrofluoroolefins include HFO-1233zd (1-chloro-3,3,3-trifluoropropene) and HFO-1336mzz (1,1,1,4,4,4-hexafluoro-2-butene).

In the present invention, one kind of blowing agent (D) may be used alone or two kinds or more of blowing agent (D) may be used in combination, but it is preferable that HFO-1233zd be solely used.

In the present invention, the content of the blowing agent other than water is not especially limited unless the effect of the present invention is impaired, and can be appropriately selected and, for example, is 5 to 40 parts by mass, preferably 5 to 30 parts by mass, more preferably 5 to 16 parts by mass based on 100 parts by mass of the total of the polyol (A) and the polyisocyanate (E).

When water is used as a blowing agent, water reacts with a polyisocyanate to form a urea, so that flame retardancy is lowered. For the reason, in the present invention, when water is used as a blowing agent, it is preferable that the content of water be decreased by using water in combination with the above-mentioned blowing agent other than water, especially a fluorocarbon, in order to suppress lowering flame retardancy due to generation of urea. Specifically, in the present invention, when water is used as a blowing agent (D), the content of water as a blowing agent (D) is less than 0.2 parts by mass based on 100 parts by mass of the total of the polyol (A) and the polyisocyanate (E). More specifically, a range of the content of water in a blowing agent (D) is preferably 0 to 0.16 parts by mass, more preferably 0 to 0.12 parts by mass, especially preferably 0 to 0.1 parts by mass.

### <Polyisocyanate (E)>

As the polyisocyanate (E) according to the present invention, a known polyisocyanate can be used. Specific examples include aromatic polyisocyanates such as toluenediisocyanate (TDI), 4,4′- or 2,4′-diphenylmethanediisocyanate (MDI) and polyphenylenepolyisocyanate (Polymeric MDI), or urethane-modified prepolymers thereof; and modified polyisocyanates preferably carbodiimide-modified.

In the present invention, the equivalent ratio of an isocyanate group in the polyisocyanate (E) to the total active hydrogen groups contained in the polyol (A), the surfactant (B), the catalyst (C) and the blowing agent (D) (NCO/OH ratio) is more than 2.0. Specifically, a range of NCO/OH ratio is preferably more than 2.0 to not more than 7.0, more preferably more than 2.0 to not more than 5.0. When NCO/OH ratio is in the range of more than 2.0 to not more than 7.0, trimerization reaction can proceed sufficiently to obtain a flame retardant polyisocyanurate foam having high flame retardancy.

In the present invention, one kind of polyisocyanate (E) may be used alone or two kinds or more of polyisocyanate (E) may be used in combination, but it is preferable that an aromatic polyisocyanate be solely used and it is especially preferable that Polymeric MDI be solely used.

In the present invention, the content of polyisocyanate (E) is not especially limited unless the effect of the present invention is impaired, and can be appropriately selected and, for example, is 50 to 80 parts by mass, preferably 52 to 78 parts by mass, more preferably 55 to 75 parts by mass based on 100 parts by mass of the total of the polyol (A) and the polyisocyanate (E).

### <Flame Retardant (F)>

The flame retardant (F) according to the present invention comprises a red phosphorus-based flame retardant and aluminum hydroxide of which the volume average diameter is not less than 40 μm when measured by laser diffractometry. In the present invention, the total content of the red phosphorus-based flame retardant and aluminum hydroxide is 6 to 36 parts by mass, preferably 9 to 35 parts by mass, more preferably 10 to 32 parts by mass based on 100 parts by mass of the total of the polyol (A) and the polyisocyanate (E). When the total content of the red phosphorus-based flame retardant and aluminum hydroxide is in this range, it is possible that high flame retardancy of the polyisocyanurate foam is achieved.

In the present invention, it is preferable that the mass ratio of the red phosphorus-based flame retardant and aluminum hydroxide be 1:1 to 1:4. When the mass ratio of the red phosphorus-based flame retardant and aluminum hydroxide is in this range, flame retardancy of the polyisocyanurate foam is significantly enhanced.

In the present invention, the red phosphorus-based flame retardant is not especially limited unless the effect of the present invention is impaired, and can be selected to use from various commercially available products. Examples of the commercially available products include Nova Red 120, 120UF and 120UFA and Nova Excel 140 and 140F, manufactured by Rin Kagaku Kogyo Co., Ltd.

In the present invention, the aluminum hydroxide is not especially limited unless the effect of the present invention is impaired, and can be selected to use from various commercially available products of which the volume average diameter is not less than 40 μm when measured by laser diffractometry. In the present invention, the volume average diameter when measured by laser diffractometry means a volume average diameter measured using Microtrac laser diffraction scattering type particle size analyzer MT3300EX-II manufactured by Nikkiso Co., Ltd. Examples of the commercially available products of aluminum hydroxide of which the volume average diameter is not less than 40 μm when measured by laser diffractometry include C-31 manufactured by Sumitomo Chemical Co., Ltd., and SB93 manufactured by Nippon Light Metal Co., Ltd.

In the present invention, the lower limit of the volume average diameter of aluminum hydroxide is 40 μm, preferably 45 μm, more preferably 50 μm, still more preferably 55 μm. In addition, in the present invention, the upper limit of the volume average diameter of aluminum hydroxide is not especially limited unless the effect of the present invention is impaired, and is preferably 250 μm, more preferably 200 μm, still more preferably 150 μm.

As the flame retardant (F) according to the present invention, in addition to the red phosphorus-based flame retardant and aluminum hydroxide, liquid flame retardants (for example tris(chloropropyl)phosphate), metal oxides (for example iron oxide, titanium oxide and ceric oxide), bromine-based compounds (for example a brominated diphenyl ether, brominated diphenylalkane and brominated phthalimide), phosphorous-based compounds (for example a phosphate ester, phosphate ester salt, amide phosphate and organic phosphine oxide) and nitrogen-based compounds (for example an ammonium polyphosphate, phosphazene, triazine and melamine cyanurate) can be used.

In the present invention, in addition to the above-mentioned raw material components (A) to (F), an auxiliary agent can be optionally used. Examples of such auxiliary agent include an emulsifying agent, stabilizer, filler, coloring agent and antioxidant. The type and content of these auxiliary agents can be appropriately selected within the range of ordinary use.

### <Process of Producing a Flame Retardant Polyisocyanurate Foam>

The flame retardant polyisocyanurate foam according to the present invention is not especially limited unless the effect of the present invention is impaired, but it is preferable to produce by mixing and stirring a polyol-containing composition comprising a polyol (A), surfactant (B), catalyst (C) and blowing agent (D) with a polyisocyanate (E) and flame retardant (F), followed by curing the resultant raw material mixture. Therefore, according to one embodiment of the present invention, a process for producing a flame retardant polyisocyanurate foam, comprising: mixing and stirring a polyol-containing composition comprising a polyol (A), surfactant (B), catalyst (C) and blowing agent (D) with a polyisocyanate (E) and flame retardant (F) to obtain a raw material mixture of the flame retardant polyisocyanurate foam; and curing the raw material mixture, wherein the catalyst (C) comprises a trimerization catalyst; the water content in the blowing agent (D) is less than 0.2 parts by mass based on 100 parts by mass of the total of the polyol (A) and the polyisocyanate (E); the flame retardant (F) comprises a red phosphorus-based flame retardant and aluminum hydroxide, and the volume average diameter of the aluminum hydroxide is not less than 40 μm when measured by laser diffractometry; and the total content of the red phosphorus-based flame retardant and the aluminum hydroxide is 6 to 36 parts by mass based on 100 parts by mass of the total of the polyol (A) and the polyisocyanate (E), is provided.

In the production of the flame retardant polyisocyanurate foam according to the present invention, the flame retardant polyisocyanurate foam can be produced by mixing and stirring the respective components using a known flame retardant polyisocyanurate foam molding machine, followed by foaming and curing the resultant raw material mixture in the molding machine. Examples of such molding machines include high pressure polyurethane molding machines and low pressure polyurethane molding machines, such as reaction injection molding machines manufactured by Cannon, Hennecke or Polyurethane Engineering Co., Ltd.

In the present invention, from the viewpoint of the effective production of the flame retardant polyisocyanurate foam, the percentages of the raw material components (A) to (F) and the like may be appropriately change to appropriately adjust cream time and gel time of the raw material mixture. As used herein, cream time means a time from the start of mixing the raw material components (A) to (F) to the start of foaming of the raw material mixture. Further, gel time means a time from initiation of mixing the raw material components (A) to (F) to a time at which raw material mixture liquid begins to be stringy when the raw material mixture is touched with a rod solid. In the present invention, a method for measuring a cream time and gel time is based on the method described in the example below.

In the raw material mixture of the flame retardant polyisocyanurate according to the present invention, the cream time is preferably 2 to 20 seconds, more preferably 4 to 15 seconds. Further, in the raw material mixture of the flame retardant polyisocyanurate according to the present invention, the gel time is preferably 20 to 200 seconds, more preferably 30 to 150 seconds.

### <Applications of Flame Retardant Polyisocyanurate Foam>

The flame retardant polyisocyanurate foam according to the present invention has excellent flame retardancy, so that it can be applied for various uses which require flame retardancy. Particularly, the flame retardant polyisocyanurate foam according to the present invention can be advantageously used as a building material and a heat insulator which are used for communal buildings such as condominiums, houses, various facilities such as schools and commercial buildings, plant piping systems, and automobiles and railway vehicles. Therefore, according to preferable embodiment, a heat insulator comprising the flame retardant polyisocyanurate foam according to the present invention is provided. In addition, according to another preferable embodiment, a building material comprising the flame retardant polyisocyanurate foam according to the present invention is provided.

### EXAMPLES

Hereinafter, the present invention will be specifically described in reference to examples, but the present invention is not limited to the examples below. It is noted that, in the examples, “part(s)” means “part(s) by mass” and “%” means “% by mass”, unless otherwise noted.

Unless otherwise noted, the following measurement methods are applied:
The isocyanate group content according EN ISO 11909 (2007).
Density according ISO 845 (2006)
The viscosity according ASTM D4878-15.
The Hydroxyl number according ASTM E222-17

### <Production of a Polyisocyanurate Foam>

The raw materials which were used for producing the flame retardant polyisocyanurate foams of the examples and comparative examples are shown in Table 1 below. The volume average diameters of the raw materials were measured using Microtrac laser diffraction scattering type particle size analyzer MT3300EX-II manufactured by Nikkiso Co., Ltd. (Laser diffraction following ISO 13320 and Representation of results of particle size analysis following ISO 9276-1).

TABLE 1

| | Components | Trade names/Compound names |
|---|---|---|
| A | Polyol 1 | RLK-087 (polyester polyol, manufactured by Kawasaki Kasei Chemicals Ltd.) |
| | | Functionality: 2 |
| | | Hydroxyl Number: 200 mg KOH/g |
| | | Viscosity: 900 mPa · s (25° C.) |
| | | Aromatic ring content: 8% |
| | Polyol 2 | RFK-509 (polyester polyol, manufactured by Kawasaki Kasei Chemicals Ltd.) |
| | | Functionality: 2 |
| | | Hydroxyl Number: 200 mgKOH/g |
| | | Viscosity: 16000 mPa · s (25° C.) |
| | | Aromatic ring content: 24% |
| B | Surfactant | B8516 (manufactured by Evonik Japan Co., Ltd.) |
| C | Catalyst 1 | Bis(2-dimethylaminoethyl) ether |
| | Catalyst 2 | Triethylmethylammonium•2-ethylhexane salt |
| | Catalyst 3 | N,N-Dimethylcyclohexylamine |
| | Catalyst 4 | Potassium Octanoate |
| D | Blowing agent 1 | Water |
| | Blowing agent 2 | Trans-1-chloro-3,3,3-trifluoropropene |
| E | Polyisocyanate | Sumidur 44V20L (manufactured by Sumika Covestro Urethane Co., Ltd.) |
| | | Isocyanate group content: 31.5% |
| F | Liquid flame retardant | TMCPP (manufactured by Daihachi Chemical Industry Co., Ltd.) |
| | Aluminum hydroxide 1 | C-301N (manufactured by Sumitomo Chemical Co, Ltd.) |
| | | Volume average diameter: 1.7 μm |
| | Aluminum hydroxide 2 | C-305 (manufactured by Sumitomo Chemical Company, Ltd.) |
| | | Volume average diameter: 7 μm |
| | Aluminum hydroxide 3 | B-316 (manufactured by TOMOE Engineering Co., Ltd.) |
| | | Volume average diameter: 25 μm |
| | Aluminum hydroxide 4 | B-325 (manufactured by TOMOE Engineering Co., Ltd.) |
| | | Volume average diameter: 34 μm |
| | Aluminum hydroxide 5 | C-31 (manufactured by Sumitomo Chemical Company, Ltd.) |
| | | Volume average diameter: 55 μm |
| | Aluminum hydroxide 6 | SB93 (manufactured by Nippon Light Metal Company, Ltd.) |
| | | Volume average diameter: 123 μm |
| | Red phosphorus-based flame | Nova Red 120UFA (manufactured by Rin Kagaku Kogyo Co., Ltd.) |
| | retardant | Volume average diameter: 12.5 μm |

For each of examples and comparative examples, each component is provided based on the composition shown in Tables 2a-2c, and polyol-containing composition comprising a polyol, surfactant, catalyst and blowing agent is mixed and stirred with a polyisocyanate and flame retardant to obtain a raw material mixture. Subsequently, 200 to 250 g of each raw material mixture which has been adjusted to 20±1° C. was poured into a polyethylene cup at a temperature of 20 to 25° C. and mixing and stirring by hand mixing for 3 seconds at stirring speed of 5000 rpm. Each resultant stirred mixture was then transferred into a wooden box (200×150×150 mm), foamed and cured to obtain the polyisocyanurate foam of each examples and comparative examples. At this time, the reactivity (cream time and gel time) and the free density for each polyisocyanurate foam were measured respectively based on the procedure below.

### <Measurement of the Reactivity and Free Density of Polyisocyanurate Foam>

### Reactivity (Cream Time and Gel Time)

The reactivity (cream time (CT) and gel time (GT)) by hand mixing for a raw material mixture of a polyisocyanurate foam of each of the examples and comparative examples was measured as an evaluation of reactivity. Specifically, a time at which each raw material mixture of polyisocyanurate foam started to be mixed by hand mixing (Homogeneous mixing device used: T. K. Robomix F Model, manufactured by Primix Corporation; Stirring blade: diameter 50 mm, sawblade; Number of revolution×Time: 5,000 rpm×3 seconds) was defined as 0 second, a time at which from the start of change in color to the start of foaming was defined as CT, and a time at which from the start of change in color to a time at which each resultant polyisocyanurate foam begins to be stringy when the polyisocyanurate foam is pricked with a disposable chopstick and the chopstick was pull out the foam was defined GT. The respective times were visually measured (average values by ten of trained panels). In the measurement of CT and GT, the amount of each raw material mixture of polyisocyanurate was 250 g, the temperature was 20° C., and the volume of polyethylene cup into which each raw material mixture of polyisocyanurate foam was placed was 500 mL. The respective results of CT and GT for each raw material mixture of polyisocyanurate foam are shown in Table 2.

### Free Density

Two 50×50×50 mm cubes were cut out using a caliper from the core portion of the resultant polyisocyanurate foam of each examples and comparative examples, the mass of each cube was measured, and the density of each polyisocyanurate foam was calculated based on the mass and volume, and the average value of two cubes was regarded as the free density in the present invention. The results are shown in Table 2.

### <Production of a Polyisocyanurate Foam Moldings>

For each example and comparative example, a composition comprising a polyol, surfactant, catalyst and blowing agent was mixed and stirred with a polyisocyanate and flame retardant based on compositions shown in Table 2 to obtain a stirred mixture in the same manner as the above-mentioned production of the polyisocyanurate foam except that the temperature of the raw material mixture of polyisocyanurate was 20° C. Subsequently, each resultant stirred mixture was transferred into an aluminum panel mold (400×300×50 mm) which has been adjusted to 50±2° C., foamed and cured to produce polyisocyanurate foam moldings of each example and comparative example (demolding time: 6 minutes). The density, core density and flame retardancy (Total heat released) for each resultant polyisocyanurate foam molding were measured respectively based on the procedure below.

### Density

The density for the resultant polyisocyanurate foam molding of each example and comparative example was measured based on the following calculating formula. The results are shown in Table 2.

Density=Mass of polyioscyanurate foam molding after mold removal÷Mold volume [Math. formula 1]

### Core Density

Two 50×50×50 mm cubes were cut out using a caliper from the core portion of the resultant polyisocyanurate foam molding of each examples and comparative examples, the mass of each cube was measured, and the density of each polyisocyanurate foam molding was calculated based on the mass and volume, and the average value of two cubes was regarded as the core density in the present invention. The results are shown in Table 2.

### Flame Retardancy (Total Heat Released)

The flame retardancy (Total heat released) for the resultant polyisocyanurate foam molding of each example and comparative example was measured based on ISO5660 using the following device and conditions.
Device: CONE CALORIMETER C4, manufactured by Toyo Seiki Seisaku-sho, Ltd.
Conditions:
   Heat Flux: 50 kW/m²
   Sample position: 60 mm (the distance from the cone heater to a sample surface)
   Heating time: 20 minutes
   Sample size: 100×100×25 mm (cut out from a core)
   Panel aging period: 3 days (after molding)
   Sample aging period: 1 day (after cutting-out)

When the measured Total heat released was not more than 8 MJ/m², it is evaluated as “Significant flame retardancy is recognized” (flame retardancy: ○), and, when the Total heat released was more than 8 MJ/m², it is evaluated as “Significant flame retardancy is not recognized” (flame retardancy: x). The results are shown in Tables 3a-3c.

TABLE 2-a
Components of Foams C. E. 1-C. E. 7, Ex. 1-Ex. 2

| Component | | Unit | C .E. 1 | C. E. 2 | C. E. 3 | C. E. 4 | C. E. 5 | C. E. 6 | C. E. 7 | Ex. 1 | Ex. 2 |
|---|---|---|---|---|---|---|---|---|---|---|---|
| A | Polyol 1 | Parts | 19.0 | 19.0 | 19.0 | 19.0 | 19.0 | 19.0 | 19.0 | 19.0 | 19.0 |
| | Polyol 2 | by | 15.5 | 15.5 | 15.5 | 15.5 | 15.5 | 15.5 | 15.5 | 15.5 | 15.5 |
| B | Foam stabilizer | Weight | 1.4 | 1.4 | 1.4 | 1.4 | 1.4 | 1.4 | 1.4 | 1.4 | 1.4 |
| C | Catalyst 1 | | 0.1 | 0.1 | 0.1 | 0.1 | 0.1 | 0.1 | 0.1 | 0.1 | 0.1 |
| | Catalyst 2 | | 0.2 | 0.2 | 0.2 | 0.2 | 0.2 | 0.2 | 0.2 | 0.2 | 0.2 |
| | Catalyst 3 | | 0.1 | 0.1 | 0.1 | 0.1 | 0.1 | 0.1 | 0.1 | 0.1 | 0.1 |
| | Catalyst 4 | | 1.0 | 1.0 | 1.0 | 1.0 | 1.0 | 1.0 | 1.0 | 1.0 | 1.0 |
| D | Foaming agent 1 | | 0.0 | 0.0 | 0.0 | 0.0 | 0.0 | 0.0 | 0.0 | 0.0 | 0.0 |
| | Foaming agent 2 | | 11.9 | 11.9 | 11.9 | 11.9 | 11.9 | 11.9 | 11.9 | 11.9 | 11.9 |
| E | Polyisocyanate | | 65.5 | 65.5 | 65.5 | 65.5 | 65.5 | 65.5 | 65.5 | 65.5 | 65.5 |
| F | Liquid flame retardant | | 5.2 | 5.2 | 5.2 | 5.2 | 5.2 | 5.2 | 5.2 | 5.2 | 5.2 |
| | Aluminium hydroxide 1 | | | | | 13.8 | | | | | |
| | Aluminium hydroxide 2 | | | | | | 13.8 | | | | |
| | Aluminium hydroxide 3 | | | | | | | 13.8 | | | |
| | Aluminium hydroxide 4 | | | | | | | | 13.8 | | |
| | Aluminium hydroxide 5 | | | 13.8 | | | | | | 13.8 | |
| | Aluminium hydroxide 6 | | | | | | | | | | 13.8 |
| | Red phosphorus-based | | | | 13.8 | 6.9 | 6.9 | 6.9 | 6.9 | 6.9 | 6.9 |
| | flame retardant | | | | | | | | | | |

| | | | | | | | | | | |
|---|---|---|---|---|---|---|---|---|---|---|
| Aluminium hydroxide | μm | n.d | 55 | n.d | 1.7 | 7 | 25 | 34 | 55 | 123 |
| Volume average diameter | | | | | | | | | | |
| Aluminium hydroxide ÷ | | n.d | n.d | n.d | 2.0 | 2.0 | 2.0 | 2.0 | 2.0 | 2.0 |
| Red phosphorus-based flame retardant | | | | | | | | | | |
| Red phosphorus-based flame retardant + | Parts by | 0 | 13.8 | 13.8 | 20.7 | 20.7 | 20.7 | 20.7 | 20.7 | 20.7 |
| Aluminium hydroxide | weight | | | | | | | | | |
| Equivalent ratio (NCO/OH) | | 3.8 | 3.8 | 3.8 | 3.8 | 3.8 | 3.8 | 3.8 | 3.8 | 3.8 |

TABLE 2-b
Components of Foams C. E. 8-C. E. 9, Ex. 3-Ex. 11

| Component | | Unit | C. E. 8 | Ex. 3 | Ex. 4 | Ex. 5 | Ex. 6 | Ex. 7 | Ex. 8 | Ex. 9 | Ex. 10 | Ex. 11 | C. E. 9 |
|---|---|---|---|---|---|---|---|---|---|---|---|---|---|
| A | Polyol 1 | Parts | 19.0 | 19.0 | 19.0 | 19.0 | 19.0 | 19.0 | 19.0 | 19.0 | 19.0 | 19.0 | 19.0 |
| | Polyol 2 | per | 15.5 | 15.5 | 15.5 | 15.5 | 15.5 | 15.5 | 15.5 | 15.5 | 15.5 | 15.5 | 15.5 |
| B | Foam stabilizer | weight | 1.4 | 1.4 | 1.4 | 1.4 | 1.4 | 1.4 | 1.4 | 1.4 | 1.4 | 1.4 | 1.4 |
| C | Catalyst 1 | | 0.1 | 0.1 | 0.1 | 0.1 | 0.1 | 0.1 | 0.1 | 0.1 | 0.1 | 0.1 | 0.1 |
| | Catalyst 2 | | 0.2 | 0.2 | 0.2 | 0.2 | 0.2 | 0.2 | 0.2 | 0.2 | 0.2 | 0.2 | 0.2 |
| | Catalyst 3 | | 0.1 | 0.1 | 0.1 | 0.1 | 0.1 | 0.1 | 0.1 | 0.1 | 0.1 | 0.1 | 0.1 |
| | Catalyst 4 | | 1.0 | 1.0 | 1.0 | 1.0 | 1.0 | 1.0 | 1.0 | 1.0 | 1.0 | 1.0 | 1.0 |
| D | Foaming agent 1 | | 0.0 | 0.0 | 0.0 | 0.0 | 0.0 | 0.0 | 0.0 | 0.0 | 0.0 | 0.0 | 0.0 |
| | Foaming agent 2 | | 11.9 | 11.9 | 11.9 | 11.9 | 11.9 | 11.9 | 11.9 | 11.9 | 11.9 | 11.9 | 11.9 |
| E | Polyisocyanate | | 65.5 | 65.5 | 65.5 | 65.5 | 65.5 | 65.5 | 65.5 | 65.5 | 65.5 | 65.5 | 65.5 |
| F | Liquid flame retardant | | 5.2 | 5.2 | 5.2 | 5.2 | 5.2 | 5.2 | 5.2 | 5.2 | 5.2 | 5.2 | 5.2 |
| | Aluminium hydroxide 1 | | | | | | | | | | | | |
| | Aluminium hydroxide 2 | | | | | | | | | | | | |
| | Aluminium hydroxide 3 | | | | | | | | | | | | |
| | Aluminium hydroxide 4 | | | | | | | | | | | | |
| | Aluminium hydroxide 5 | | 3.5 | 6.9 | 6.9 | 10.4 | 10.7 | 13.8 | 13.8 | 17.3 | 20.7 | 20.7 | 24.2 |
| | Aluminium hydroxide 6 | | | | | | | | | | | | |
| | Red phosphorus-based | | 1.7 | 3.5 | 6.9 | 5.2 | 5.4 | 3.5 | 10.4 | 8.6 | 6.9 | 10.4 | 12.1 |
| | flame retardant | | | | | | | | | | | | |

| | | | | | | | | | | | | |
|---|---|---|---|---|---|---|---|---|---|---|---|---|
| Aluminium hydroxide | μm | 55 | 55 | 55 | 55 | 55 | 55 | 55 | 55 | 55 | 55 | 55 |
| Volume average diameter | | | | | | | | | | | | |
| Aluminium hydroxide ÷ | | 2.0 | 2.0 | 1.0 | 2.0 | 2.0 | 4.0 | 1.3 | 2.0 | 3.0 | 2.0 | 2.0 |
| Red phosphorus-based flame retardant | | | | | | | | | | | | |
| Red phosphorus-based flame retardant + | Parts by | 5.2 | 10.4 | 13.8 | 15.5 | 16.1 | 17.3 | 24.2 | 25.9 | 27.6 | 31.1 | 36.3 |
| Aluminium hydroxide | weight | | | | | | | | | | | |
| Equivalent ratio (NCO/OH) | | 3.8 | 3.8 | 3.8 | 3.8 | 3.8 | 3.8 | 3.8 | 3.8 | 3.8 | 3.8 | 3.8 |

TABLE 2-c
Components of Foams Ex. 12-Ex. 15, C.E. 10-C.E. 11

| Component | | Unit | Ex. 12 | C. E. 10 | Ex. 13 | Ex. 1 | Ex. 14 | Ex. 15 | C. E. 11 |
|---|---|---|---|---|---|---|---|---|---|
| A | Polyol 1 | Parts | 19.0 | 18.9 | 15.8 | 19.0 | 22.1 | 24.6 | 27.6 |
| | Polyol 2 | per | 15.5 | 15.5 | 13.0 | 15.5 | 18.1 | 20.1 | 22.6 |
| B | Foam stabilizer | weight | 1.4 | 1.4 | 1.2 | 1.4 | 1.6 | 1.8 | 2.0 |
| C | Catalyst 1 | | 0.1 | 0.1 | 0.1 | 0.1 | 0.1 | 0.1 | 0.1 |
| | Catalyst 2 | | 0.2 | 0.2 | 0.1 | 0.2 | 0.2 | 0.2 | 0.2 |
| | Catalyst 3 | | 0.1 | 0.1 | 0.1 | 0.1 | 0.1 | 0.1 | 0.1 |
| | Catalyst 4 | | 1.0 | 1.0 | 0.9 | 1.0 | 1.2 | 1.2 | 1.2 |
| D | Foaming agent 1 | | 0.1 | 0.2 | 0.0 | 0.0 | 0.0 | 0.0 | 0.0 |
| | Foaming agent 2 | | 11.9 | 11.9 | 9.9 | 11.9 | 13.8 | 15.3 | 17.2 |
| E | Polyisocyanate | | 65.5 | 65.5 | 71.2 | 65.5 | 59.8 | 55.3 | 49.7 |
| F | Liquid flame retardant | | 5.2 | 5.2 | 4.3 | 5.2 | 6.0 | 6.7 | 7.5 |
| | Aluminium hydroxide 1 | | | | | | | | |
| | Aluminium hydroxide 2 | | | | | | | | |
| | Aluminium hydroxide 3 | | | | | | | | |
| | Aluminium hydroxide 4 | | | | | | | | |
| | Aluminium hydroxide 5 | | 13.8 | 13.8 | 11.5 | 13.8 | 16.1 | 17.9 | 20.1 |
| | Aluminium hydroxide 6 | | | | | | | | |
| | Red phosphorus-based | | 6.9 | 6.9 | 5.6 | 6.9 | 8.0 | 8.9 | 10.1 |
| | flame retardant | | | | | | | | |

| | | | | | | | | |
|---|---|---|---|---|---|---|---|---|
| Aluminium hydroxide | μm | 55 | 55 | 55 | 55 | 55 | 55 | 55 |
| Volume average diameter | | | | | | | | |
| Aluminium hydroxide ÷ | | 2.0 | 2.0 | 2.0 | 2.0 | 2.0 | 2.0 | 2.0 |
| Red phosphorus-based flame retardant | | | | | | | | |
| Red phosphorus-based flame retardant + | Parts by | 20.7 | 20.7 | 17.1 | 20.7 | 24.1 | 26.8 | 30.2 |
| Aluminium hydroxide | weight | | | | | | | |
| Equivalent ratio (NCO/OH) | | 3.8 | 3.8 | 5.0 | 3.8 | 3.0 | 2.5 | 2.0 |

TABLE 3a
Properties of Foams C.E.1-C.E. 7, Ex 1-Ex.2

| Component | | Unit | C. E. 1 | C. E. 2 | C. E. 3 | C. E. 4 | C. E. 5 | C. E. 6 | C. E. 7 | Ex. 1 | Ex.2 |
|---|---|---|---|---|---|---|---|---|---|---|---|
| Reactivity | Cream time | sec. | 6 | 8 | 8 | 7 | 7 | 7 | 7 | 7 | 7 |
| | Gel time | sec. | 41 | 47 | 42 | 48 | 51 | 50 | 52 | 49 | 50 |
| | Free density | kg/m³ | 36.8 | 44.7 | 41.3 | 43.1 | 43.1 | 43.1 | 43.1 | 43.1 | 43.1 |
| Density | | kg/m³ | 55 | 62 | 62 | 64 | 64 | 64 | 64 | 64 | 64 |
| Core density | | kg/m³ | 49 | 55 | 55 | 57 | 57 | 57 | 57 | 57 | 58 |
| Combustibility | Gross calorific | MJ/m² | 24.7 | 15.5 | 8.9 | 23.7 | 15.5 | 10.3 | 8.4 | 5.8 | 3.4 |
| | value | | | | | | | | | | |
| | Judge | | × | × | × | × | × | × | × | ○ | ○ |

TABLE 3b
Properties of Foams C. E. 8-C. E. 9, Ex. 3-Ex. 11

| Component | | Unit | C. E. 8 | Ex. 3 | Ex. 4 | Ex. 5 | Ex. 6 | Ex. 7 | Ex. 8 | Ex. 9 | Ex. 10 | Ex. 11 | C. E. 9 |
|---|---|---|---|---|---|---|---|---|---|---|---|---|---|
| Reactivity | Cream time | sec. | 8 | 7 | 7 | 7 | 7 | 8 | 8 | 8 | 8 | 8 | 8 |
| | Gel time | sec. | 43.3 | 42 | 43 | 49 | 49 | 48 | 55 | 57 | 62 | 115 | 57 |
| | Free density | kg/m³ | 44.3 | 39.2 | 39.5 | 40.8 | 40.8 | 43.8 | 42.4 | 45 | 48.6 | 45 | 48 |
| Density | | kg/m³ | kg/m³ | 57 | 62 | 58 | 58 | 63 | 66 | 69 | 66 | 70 | 65 |
| Core density | | kg/m³ | kg/m³ | 52 | 55 | 51 | 51 | 56 | 60 | 63 | 60 | 65 | 59 |
| Combustibility | Gross calorific | MJ/m² | 10.8 | 8.0 | 7.7 | 7.1 | 6.6 | 7.4 | 6.3 | 5.4 | 7.2 | 7.7 | 10.2 |
| | value | | | | | | | | | | | | |
| | Judge | | × | ○ | ○ | ○ | ○ | ○ | ○ | ○ | ○ | ○ | × |

TABLE 3-c
Properties of Foams Ex. 12-Ex. 15, C. E. 10-C. E. 11

| Component | | Unit | Ex. 12 | C. E. 10 | Ex. 13 | Ex. 1 | Ex. 14 | Ex. 15 | C. E. 11 |
|---|---|---|---|---|---|---|---|---|---|
| Reactivity | Cream time | sec. | 7 | 7 | 7 | 7 | 7 | 7 | 7 |
| | Gel time | sec. | 40 | 33 | 52 | 49 | 46 | 45 | 46 |
| | Free density | kg/m³ | 41.4 | 39.3 | 40 | 43.1 | 47.4 | 48.8 | 49.3 |
| Density | | kg/m³ | 55 | 62 | 58 | 63 | 64 | 64 | 64 |
| Core density | | kg/m³ | 49 | 55 | 52 | 57 | 57 | 57 | 58 |
| Combustibility | Gross calorific | MJ/m² | 7.2 | 9.3 | 5.7 | 5.8 | 6.9 | 7.9 | 13.8 |
| | value | | | | | | | | |
| | Judge | | ○ | × | ○ | ○ | ○ | ○ | × |

The results shown in Tables 3a-3c show that any Total heat released measured based on ISO5660 in Examples 1 to 15 (Ex. 1-Ex. 15) were not more than the criterion value (8 MJ/m²), so that the samples have significant flame retardancy.

On the other hand, the results shown in Tables 3a show that the Total heat released measured based on ISO5660 in Comparative example 1 (C.E. 1) in which neither red phosphorus-based flame retardant nor aluminum hydroxide were contained as a flame retardant was a result (24.7 MJ/m²) much greater than the criterion value (8 MJ/m²), so that significant flame retardancy was not recognized.

In Comparative Examples 2 and 3 in which only one of a red phosphorus-based flame retardant or aluminum hydroxide were contained as a flame retardant, any Total heat released were greater than the criterion value, so that significant flame retardancy was not recognized.

In Comparative Examples 4 to 7 in which a red phosphorus-based flame retardant and aluminum hydroxide were contained as a flame retardant, but the volume average diameter of the aluminum hydroxide was less than 40 μm, any Total heat released were greater than the criterion value, so that significant flame retardancy was not recognized. It is noted that, in Examples 1 and 2, the foams were produced based on the same composition as Comparative Examples 4 to 7 except that aluminum hydroxide of which the volume average diameter was not less than 40 μm was used, and that any Total heat released were not more than the criterion value, so that they are shown to have significant flame retardancy. Taking account that it was conventionally known that, when aluminum hydroxide was used as a flame retardant, as the particle diameter of aluminum hydroxide was smaller, the decomposition reaction of the aluminum hydroxide was accelerated more, so that higher flame retardant effect was exhibited, it is an unexpected result that, in Examples 1 and 2 in which aluminum hydroxide of which the particle diameter was larger was used, more significant flame retardancy was exhibited.

In Comparative Examples 8 and 9 in which the red phosphorus-based flame retardant and aluminum hydroxide were contained as a flame retardant, but the total content thereof was less than 6 parts by mass (5.2 parts by mass) in Comparative Example 8, and more than 36 parts by mass (36.3 parts by mass) in Comparative Example 9, based on 100 parts by mass of the total amount of the polyol and the polyisocyanate, any Total heat released were greater than the criterion value, so that significant flame retardancy was not recognized. It is considered that, in Comparative Example 8, sufficient flame retardancy could not be obtained because of a small absolute amount of red phosphorus-based flame retardant and aluminum hydroxide. Further, it is considered that, in Comparative Example 9, the viscosity of the polyol and isocyanate was increased as a result of the large content of the red phosphorus-based flame retardant and aluminum hydroxide, so that mixing and stirring of the raw material mixture was insufficient, whereby a trimerization reaction to form an isocyanurate structure exhibiting flame retardancy was prevented, so that sufficient flame retardancy could not be obtained.

In Comparative Example 10 in which water was contained as a blowing agent and the content of the water was not less than 0.2 parts by mass (0.2 parts by mass) based on 100 parts by mass of the total amount of the polyol and the polyisocyanate, the Total heat released was greater than the criterion value, so that significant flame retardancy was not recognized. On the other hand, in Example 12 in which the content of water as a blowing agent was 0.1 parts by mass, the Total heat released was not more than the criterion value, so that it was shown to have significant flame retardancy. It is considered that the reason is that urea in the flame retardant polyisocyanurate foam is increased by reaction of water with isocyanate, and, when the water content is large, lowers flame retardancy.

In Comparative Example 11 in which the equivalent ratio of the isocyanate group of polyisocyanate to the total active hydrogen groups contained in the polyol, the surfactant, the catalyst and the blowing agent (D) (NCO/OH ratio) is not more than 2.0, the Total heat released was greater than the criterion value, so that significant flame retardancy was not recognized. On the other hand, in Examples 1 to 15 in which the equivalent ratio is more than 2.0, the Total heat released was not more than the criterion value, so that they are shown to have significant flame retardancy. It is considered that the reason is that a trimerization reaction by trimerization catalyst proceeds sufficiently, whereby the isocyanurate structure which is advantageous to thermal resistance in the polyisocyanurate foam is increased to enhance flame retardancy.

### Industrial Applicability

The flame retardant polyisocyanurate foam according to the present invention has excellent flame retardancy, so that it can be used as a building material and a heat insulator in various uses which require flame retardancy. In particular, the flame retardant polyisocyanurate foam according to the present invention can be used as a heat insulator and building material in communal buildings such as condominiums, houses, and various facilities such as schools and commercial buildings, as well as a heat insulator in plant piping systems which need flame retardancy, and automobiles and railway vehicles.

1. A flame retardant polyisocyanurate foam, comprising a cured reaction product of a raw material mixture comprising a polyol (A), a surfactant (B), a catalyst (C), a blowing agent (D), a polyisocyanate (E) and a flame retardant (F), wherein:
the catalyst (C) comprises a trimerization catalyst;
the blowing agent (D) has a water content of less than 0.2 parts by mass based on 100 parts by mass of the total of the polyol (A) and the polyisocyanate (E);
the flame retardant (F) comprises a red phosphorus-based flame retardant and aluminum hydroxide, and the volume average diameter of the aluminum hydroxide is not less than 40 μm when measured by laser diffractometry;
the total content of the red phosphorus-based flame retardant and the aluminum hydroxide is 6 to 36 parts by mass based on 100 parts by mass of the total of the polyol (A) and the polyisocyanate (E); and
the equivalent ratio of an isocyanate group in the polyisocyanate (E) to the total active hydrogen groups contained in the polyol (A), the surfactant (B), the catalyst (C) and the blowing agent (D) is more than 2.0.

2. The flame retardant polyisocyanurate foam according to claim 1, wherein the mass ratio of the red phosphorus-based flame retardant to the aluminum hydroxide is 1:1 to 1:4.

3. The flame retardant polyisocyanurate foam according to claim 1, wherein the polyol (A) comprises a polyester polyol having a functionality of 2 to 3 and a Hydroxyl Number of 100 to 400 mg KOH/g.

4. The flame retardant polyisocyanurate foam according to claim 1, wherein the polyol (A) comprises a polyester polyol having an aromatic ring content of 8% to 30% by mass.

5. The flame retardant polyisocyanurate foam according to claim 1, wherein the polyisocyanate (E) comprises an aromatic polyisocyanate, a modified aromatic polyisocyanate, or a combination thereof.

6. The flame retardant polyisocyanurate foam according to claim 1, wherein the blowing agent (D) comprises a hydrofluoroolefin, a hydrochlorofluoroolefin, water, hydrocarbon, or a combination of any two or more thereof.

7. The flame retardant polyisocyanurate foam according to claim 1, wherein the blowing agent (D) comprises trans-1-chloro-3,3,3-trifluoropropene.

8. The flame retardant polyisocyanurate foam according to claim 1, wherein the foam has a core density of 30 to 80 kg/m³.

9. The flame retardant polyisocyanurate foam according to claim 1, wherein the total heat released from the foam is not more than 8 MJ/m² when measured by the non-combustibility test based on ISO5660.

10. A heat insulator, comprising the flame retardant polyisocyanurate foam according to claim 1.

11. A building material, comprising the flame retardant polyisocyanurate foam according to claim 1.
